(19) United States
(12) Patent Application Publication
(10) Pub. No.: US 2005/0237452 A1
(43) Pub. Date: Oct. 27, 2005

(54) Electro-optical device and electronic apparatus

(75) Inventors: Hiroyuki Kojima, Suwa-shi (JP); Tomoaki Miyashita, Shimosuwa-machi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/103,530

(22) Filed: Apr. 12, 2005

(30) Foreign Application Priority Data
Apr. 22, 2004 (JP) 2004-127026
Mar. 14, 2005 (JP) 2005-070485

(51) Int. Cl. G02F 1/1335

(52) U.S. Cl. 349/113

(57) ABSTRACT

An electro-optical device includes a pair of substrates having an electro-optical material therebetween, pixels that are provided on one of the pair of substrates, and a plate member which includes spinel and is provided on a surface of at least one of the pair of substrates opposite to the electro-optical material.

### BACKGROUND OF THE INVENTION

1. Technical Field

The present invention relates to an electro-optical device, such as a liquid crystal device, an electrophoresis device, or an EL (electro-luminescent) device, a method of manufacturing the electro-optical device, and an electronic apparatus having the electro-optical device as a light valve.

2. Related Art

An electronic apparatus, such as a projection display apparatus, including electro-optical devices as light valves, modulates light emitted from a light source and then projects the modulated light onto a screen as an image. The electro-optical device includes a display panel having a light modulating function, such as a liquid crystal device, and optical plate members, such as a polarizing plate or dustproof substrates provided on at least one surface of the display panel.

The dustproof substrate functions to prevent the deterioration of display quality caused by dust. That is, dust stuck to the display surface of the electro-optical device is enlarged and projected onto the screen as an image. However, when the display surface is covered with the dustproof substrate, the sticking of dust to the display surface is prevented. Therefore, even if dust becomes stuck to the dustproof substrate, the image of dust is not formed since the dustproof substrate has a predetermined thickness, which is called a defocus effect. Thus, it is possible to solve the problem of an image of dust being projected onto the screen.

The dustproof substrate needs to have high transmittance and high heat conductivity. That is, it is necessary to transmit light at high transmittance in order to secure display brightness. Further, in the projection display device, since very intense light is incident on the electro-optical device, the electro-optical device generates heat by the absorption of light. Thus, in order to prevent the deterioration of the electro-optical device caused by the generation of heat, it is important to effectively radiate the heat of the electro-optical device to the outside.

As substrate materials satisfying the above-mentioned conditions, quartz glass, Neoceram, sapphire, etc., have been widely used (see Japanese Unexamined Patent Application Publication Nos. 9-113906 and 2000-284700). In particular, sapphire has heat conductivity, several tens of times higher than quartz glass.

However, sapphire has a relatively large refractive index anisotropy. Therefore, when a sapphire substrate is bonded to a display panel, a projection display device using the polarizing effect has technical problems in that the contrast deteriorates and the viewing angle varies.

### SUMMARY

An advantage of the invention is that it provides an electro-optical device capable of preventing the deterioration of display-quality and of improving a cooling effect, a method of manufacturing the same, and an electronic apparatus equipped with the electro-optical device.

According to a first aspect of the invention, an electro-optical device includes a pair of substrates having an electro-optical material therebetween, pixels that are provided on one of the pair of substrates, and a plate member which includes spinel and is provided on a surface of at least one of the pair of substrates opposite to the electro-optical material.

According to the electro-optical device of the first aspect, the variation of the state of the electro-optical material interposed between the pair of substrates is controlled, so that projection light incident on the electro-optical device is modulated. That is, the projection light is incident on one of the pair of substrates, and is then emitted from the other substrate. Herein, a plate member is provided on a surface of at least one of the pair of substrates opposite to the electro-optical material, and the plate member functions as a so-called dustproof substrate. Therefore, it is possible to effectively prevent the deterioration of display quality caused by dust as described above. Here, in the invention, the term ‘plate member’ refers to a plate member having an optical property or optical function, such as a dustproof substrate having the defocus effect or a polarizing plate.

According to the electro-optical device of the first aspect, the plate member includes spinel (MgAl₂O₄). The spinel has little or no optical anisotropy. It is thought that this is because the spinel has an isometric crystal structure. However, the plate member preferably includes a sufficient amount of spinel to exhibit a noticeable physical effect and includes a low level of impurities. In addition, the plate member including the spinel is manufactured by, for example, a powder sintering method.

Further, an incident angle of projection light with respect to the substrate generally varies in the plane of the substrate. When a substrate having a relatively large refractive index anisotropy, such as a sapphire substrate, is used as a plate member, the viewing angle is varied, or the contrast is partially deteriorated in the direction in which the refractive index anisotropy is exhibited. The term ‘the variation of the viewing angle’ means that the viewing angle is narrowed or the clear viewing direction is varied. Therefore, it is necessary to adjust the position of the sapphire substrate such that specifications that the user desires, such as the viewing angel, are obtained, and to align the sapphire substrate in the direction in which the anisotropy is exhibited.

On the other hand, since the plate member including the spinel has little or no refractive index anisotropy, it is possible to prevent the generation of defects in display. Therefore, it is possible to prevent the deterioration of display quality in the electro-optical device. In addition, it is not necessary to adjust the position of the plate member unlike the sapphire substrate, so that it is possible to cope with any specifications.

Further, since the heat conductivity of spinel is about ten times higher than that of quartz glass, the plate member can more effectively absorb heat from the substrate and radiate it to the outside. In other words, the plate member functions as a heat sink. Thus, it is possible to more effectively cool down an electro-optical device.

As described above, according to the electro-optical device of the first-aspect, it is possible to solve the problems caused by the dust or refractive index anisotropy of the optical plate member and to display a high-quality image. In addition, it is possible to prevent the deterioration of an electro-optical material and to stably operate a liquid crystal device by effectively cooling down the liquid crystal device during driving.

Furthermore, the structure in which the plate member is provided on ‘the surface of at least one of the pair of substrates opposite to the electro-optical material’ includes three patterns in which the plate member is provided on the light incident side, the light emission side, and both the sides of the electro-optical device, respectively.

According to a second aspect, an electro-optical device includes a pair of substrates having an electro-optical material therebetween, pixels that are provided on one of the pair of substrates, and a plate member which includes YAG (Yttrium Aluminum Garnet) and is provided on a surface of at least one of the pair of substrates opposite to the electro-optical material.

According to the electro-optical device of the second aspect, similar to the electro-optical device according to the first embodiment, the plate member functions as a dustproof substrate. Thus, it is possible to effectively prevent the deterioration of display quality caused by dust.

In this case, the plate member includes YAG. The YAG has little or no optical anisotropy. It is thought that this is because the YAG has an isometric crystal structure. However, the plate member should include a sufficient amount of YAG to exhibit a noticeable physical effect, and may have a low level of impurities. In addition, the plate member including the YAG is manufactured by, for example, a powder sintering method or a slip casting method.

As such, since the plate member including YAG has little or no refractive index anisotropy, it is possible to completely solve the problems in display caused by the refractive index anisotropy raised when the sapphire substrate is used, as described above. Thus, it is possible to prevent the deterioration of display quality in an electro-optical device.

Furthermore, since the heat conductivity of the YAG is about ten times higher than that of quartz glass, the optical plate member can more effectively absorb heat from the substrate and radiate it to the outside of the substrate. Thus, it is possible to more effectively radiate the heat of an electro-optical device.

According to the electro-optical device of the second aspect, it is possible to solve the problems caused by the dust or refractive index anisotropy of the optical plate member and to display a high-quality image. In addition, it is possible to prevent the deterioration of an electro-optical material and to stably operate a liquid crystal device by effectively cooling down the liquid crystal device during driving.

Further, it is preferable that the composition of the YAG included in the plate member be Y₃Al₅O₁₂.

According to this structure, the basic composition of the YAG included in the member plate is defined by the composition formula Y₃Al₅O₁₂. This is a typical composition of the YAG. However, the YAG may include indium (Y), aluminum (Al), and oxygen at a composition ratio-different from the above-mentioned composition formula. Herein, using Y₃Al₅O₁₂ as the basic composition means that a little variation of composition or transformation by impurities can be permitted.

As such, it is possible to more reliably obtain the effect and operation by the above-mentioned plate member by using YAG having the basic composition of Y₃Al₅O₁₂.

Further, it is preferable that the plate member be made of a polycrystalline material.

According to this structure, since the plate member of the electro-optical device according to the first aspect including the spinel or the plate member of the electro-optical device according to the second aspect including the YAG is made of a polycrystalline material, the directivity in the direction in which the optical anisotropy thereof is exhibited is low as a whole. As a result, the optical anisotropy of the entire surface of the optical plate member can be controlled.

Therefore, in the electro-optical device of the invention, it is possible to more reliably prevent the partial deterioration of the contrast caused by the refractive index anisotropy of the plate member or the variation of the viewing angle.

Furthermore, it is preferable that the plate member be a member obtained by sintering powder.

According to this structure, since the plate member of the electro-optical device according to the first embodiment including the spinel or the plate member of the electro-optical device according to the second embodiment including the YAG is manufactured by sintering powder, it is possible to very simply manufacture the plate member.

Moreover, it is preferable that the plate member be provided on the surface of one of the pair of substrates opposite to the electro-optical material, and that a second plate member including neither spinel nor YAG be provided on a surface of the other substrate of the pair of substrates opposite to the electro-optical material.

According to this structure, the plate members made of different materials are provided on both surfaces of the electro-optical device. Since the above-mentioned plate member is provided on one substrate, it is possible to effectively cool down the electro-optical device and to maintain high-quality display. In addition, it is possible to reduce the use of the relatively expensive spinel or YAG, thereby reducing the total manufacturing cost of an electro-optical device.

As described above, when the plate members made of different materials are respectively provided on both surfaces of one electro-optical device, it is preferable that the plate member of the invention including spinel or YAG be provided on the light incident side of the electro-optical device, in consideration of the characteristics of the second plate member including heat conductivity.

Further, it is preferable that a polarizing element be further provided on the surface of at least one of the pair of substrates opposite to the electro-optical material.

According to this structure, it is possible to properly polarize light incident on the electro-optical material or light emitted from the electro-optical material. This polarizing element is generally arranged at the more outer side than the plate member, as viewed from the substrate of the electro-optical device. That is, the polarizing element is provided on the substrate with the plate member interposed therebetween.

Particularly, the following effects and operations can be obtained by arranging the plate member including spinel or YAG and the polarizing element. That is, when the plate member arranged in the electro-optical device is made of, for example, crystal or sapphire, the refractive index anisotropy has an effect on the light polarized by the polarizing element.

On the contrary, since the plate member of the invention includes spinel or YAG having little or no refractive index anisotropy, the lowering of the contrast or the variation of the viewing angle does not occur or hardly occurs even when the polarized light is incident on the plate member. For example, in general, when the plate member having the refractive index anisotropy is used, the polarizing axis of the plate member having the refractive index anisotropy should be aligned with the polarizing axis of the polarizing element. However, in the invention, the alignment of the polarizing axes is not needed, which is very advantageous in practice. Therefore, it is possible to display a high-quality image in a relatively easy method.

Further, a third plate member made of spinel or YAG will be provided on the polarizing element.

According to this structure, since the heat generated from the polarizing element is absorbed to the plate member including spinel or YAG having relatively high heat conductivity, it is possible to appropriately cool down the polarizing element.

Furthermore, the electro-optical device according to this aspect further includes optical compensation elements, such as a λ/4 plate, a λ/2 plate, and an optical compensation film for a wide viewing angle, in addition to the polarizing element, and the plate members including spinel or YAG may be also provided on the optical compensation elements, respectively.

Moreover, it is preferable that an AR (Anti-Reflection) film be provided on at least one surface of the plate member.

According to this structure, since the spinel and YAG have relatively large refractive indexes of about 1.7 and 1.8, respectively, light incident on the plate member or light emitted therefrom is mostly reflected from the interface thereof. However, in this aspect, since the AR film is provided on at least one surface of the plate member, it is possible to prevent the reflection of light from the interface. Thus, it is possible to improve the usage efficiency of transmission light in an electro-optical device, which results in brighter display.

Further, the ‘AR film’ is composed of, for example, a multi-layered film of a zirconia (ZrO₂) film and a silica (SiO₂) film. More specifically, the zirconia films- and the silica films having different refractive indexes may be alternately deposited. In addition, it is possible to obtain the desired optical characteristics, such as a refractive index, by changing a material for forming the AR film, the thicknesses of the respective layers, the number of layers, etc.

Furthermore, it is preferable that the electro-optical device further include a case in which at least the pair of substrates and the plate member are encased and which is composed of a plurality of detachable components.

According to this structure, basically, the pair of substrates and the plate members provided corresponding to the substrates are housed in the case. However, the above-mentioned polarizing element and the plate member corresponding thereto may also be housed in the case. When the polarizing element, etc., are further provided, generally, the pair of substrates and the plate members provided corresponding to the substrates are housed in the case, and the polarizing element and the plate member provided corresponding thereto are arranged at the outside of the case. In addition, for example, the case is composed of a plurality of detachable portions, such as a plate arranged opposite to the surface of the substrate and a cover arranged to cover the plate and the encased components.

The heat generated from the substrates, etc., when the electro-optical device is driven is transmitted to the case as well as the plate member. That is, in this case, the case functions as a heat sink for absorbing internal heat to radiate it to the outside. Thus, it is possible to more reliably prevent the accumulation of heat in an electro-optical device.

Further, the case may be made of a metallic material having heat conductivity higher than about 15 W/m·K to more effectively perform the function of the heat sink. The metallic material may include, for example, aluminum, magnesium, copper, and an alloy thereof. In addition, when the case is constructed so as to come into contact with the plate member, heat conductivity between the case and the plate member is improved, which makes it possible to more effectively cool down an electro-optical device.

An electronic apparatus of the invention includes the above-mentioned electro-optical device (including various aspects thereof) in order to solve the above-mentioned problems.

Since the electronic apparatus of the invention has the above-mentioned electro-optical device, it is possible to prevent the deterioration of display quality caused by the sticking of dust and to more effectively cool down an electro-optical panel with a simple structure in the electronic apparatus.

Further, a method of manufacturing the plate member includes a process of mixing powder including YAG with a dissolvent to prepare slurry, a process of pouring the slurry into a mold and of hardening it to prepare a precursor of the plate member, and a process of sintering the precursor of the plate member to form the plate member.

According to the method of manufacturing the electro-optical device of the invention, the powder including YAG is prepared, and then the powder is mixed with pure water to make slurry. Subsequently, the slurry is poured into a mold and is then hardened to obtain a plate-shaped precursor of the plate member. Then, the precursor is sintered to obtain the plate-member of the invention.

Generally, the member is formed in such a manner that the powder is injected into the mold, and then pressure is applied thereto. However, in this case, the member may be cracked when pressure is applied. On the contrary, in the manufacturing method of the invention, since the member is formed by a so-called slip casting method in which the slurry is poured in the mold, the molded part (that is, the precursor) is hardly damaged. Thus, it is possible to simply manufacture the plate member and thus to improve the manufacturing efficiency of an electro-optical device.

Furthermore, it is preferable that the plate member have little or no optical anisotropy from the viewpoint of use. For this reason, it is necessary to control the crystal structure thereof.

The above-mentioned operations and other advantages of the invention can be apparently seen from the following embodiments.

### BRIEF DESCRIPTION OF THE DRAWINGS

The invention will be described with reference to the accompanying drawings, wherein like numbers refer to like elements, and wherein:

FIG. 1 is a plan view illustrating the overall structure of a projection display device according to an embodiment of the invention;

FIG. 2 is a plan view illustrating the structure of a liquid crystal device according to a first embodiment of the invention;

FIG. 3 is a cross-sectional view taken along the line H-H′ of FIG. 2;

FIG. 4 is a cross-sectional view illustrating a modification of the liquid crystal device according to the first embodiment;

FIG. 5 is a cross-sectional view illustrating another modification of the liquid crystal device according to the first embodiment;

FIG. 6 is a cross-sectional view illustrating the structure of a liquid crystal device according to a second embodiment;

FIG. 7 is a flow chart illustrating the main processes of a method of manufacturing the liquid crystal device according to the second embodiment; and

FIG. 8 is an exploded perspective view illustrating a liquid crystal device according to a third embodiment in a state in which a case is exploded.

### DESCRIPTION OF THE EMBODIMENTS

Hereinafter, embodiments of the invention will be described with reference to the accompanying drawings.

### Embodiment of Projection Display Device

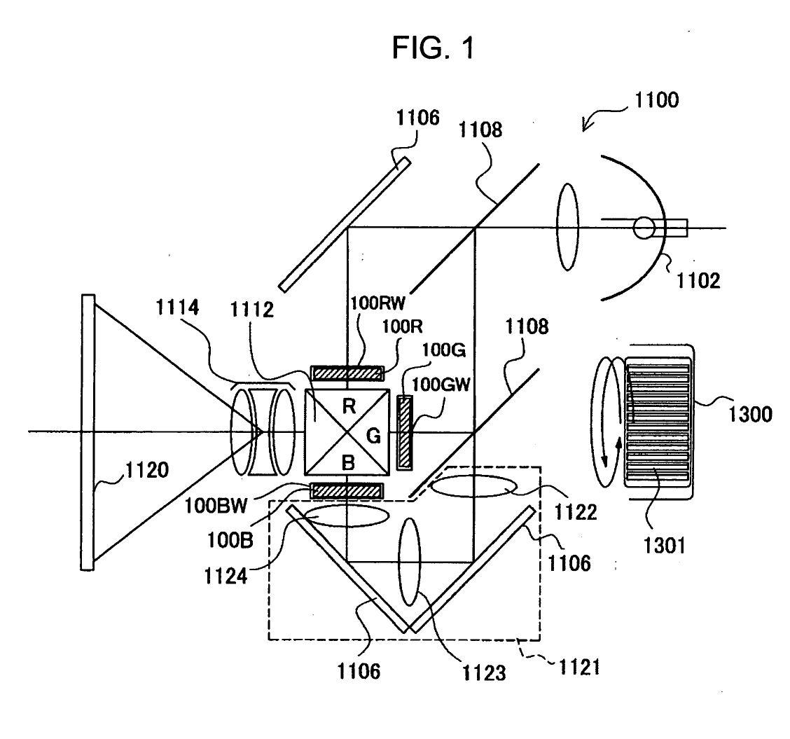

First, a projection display device according to an embodiment of the invention will be described with reference to FIG. 1. FIG. 1 shows the structure of the projection display device of this embodiment.

In FIG. 1, a projection display device 1100 is composed of a liquid crystal color projector in which liquid crystal devices, serving as electro-optical devices of the invention, are respectively used as R, G, and B light valves 100R, 100G, and 100G.

In the projection display device 1100, when projection light is emitted from a lamp unit 1102, which is a white light source, such as a metal halide lamp, it is separated into-three light components R, G, and B corresponding to the three primary colors by three mirrors 1106 and two dichroic mirrors 1108. Then, the separated light components are guided to the respective light valves 100R, 100G, and 100B. In order to prevent the loss of the B light component caused by its long optical path, the B light component is led through a relay lens system 1121 including a light incident lens 1122, a relay lens 1123, and a light emission lens 1124. Thereafter, the light components corresponding to the three primary colors that have been modulated by the respective light valves 100R, 100G, and 100B are resynthesized by a dichroic prism 1112, and are then projected, as a color image, onto a screen 1120 through a projection lens 1114.

For example, active matrix liquid crystal devices having TFTs, which will be described later, serving as switching elements, are used as the light valves 100R, 100G, and 100B. These liquid crystal devices are housed in a case.

Further, a sirocco fan 1300 for sending cooling air to the light valves 100R, 100G, and 100B is provided in the projection display device 1100. The sirocco fan 1300 includes a substantially cylindrical member having a plurality of blades 1301 on the side thereof, and in the sirocco fan, the cylindrical member rotates on its central axis to cause the blades 1301 to generate wind. Incidentally, the wind generated by the sirocco fan 1300 in accordance with such a principle flows in whirls, as shown in FIG. 1. The wind is supplied to the respective light valves 100R, 100G, and 100B through air passages (not shown in FIG. 1). In addition, as described above, when the sirocco fan 1300 is used, it is possible to obtain an advantage in that the wind is easily supplied to narrow spaces around the light valves 100R, 100G, and 100B because the wind has a high static pressure.

In the above-mentioned structure, the light emitted from the lamp unit 1102, which is an intense light source, raises the temperature of the light valves 100R, 100G, and 100B when they are driven. At that time, if the temperature rises excessively, the liquid crystal constituting the light valves 100R, 100G, and 100B may be deteriorated, or hot spots generated by the partial heating of portions of the liquid crystal panel due to uneven light emitted from the light source may cause variations in the transmittance. In addition, dust may become stuck on the respective light valves 100R, 100G, and 100B. In this case, an image of the dust may be projected onto the screen 1120.

Therefore, in the present embodiment, the respective light valves 100R, 100G, and 100B are mounted on the outer surface of the case together with optical plate members, which will be described later.

### First Embodiment of Liquid Crystal Device

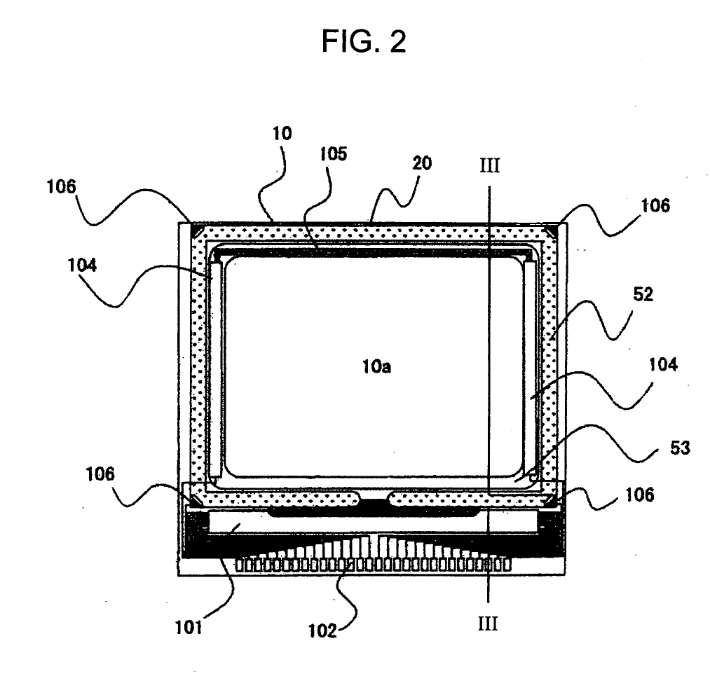

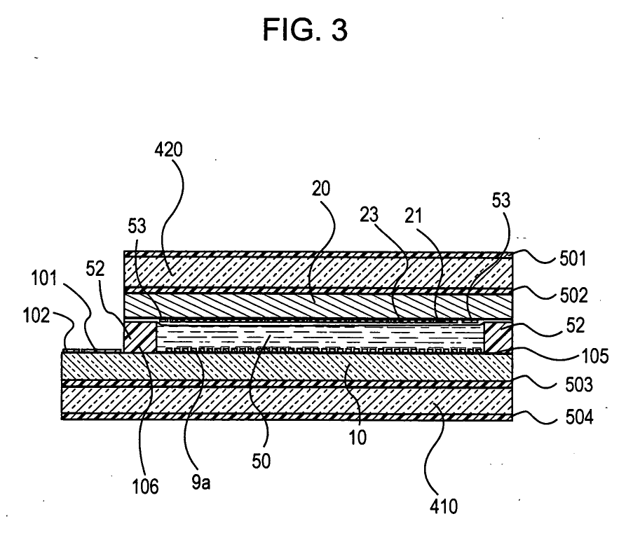

Next, a liquid crystal device of the present embodiment will be described with reference to FIGS. 2 and 3. That is, the liquid crystal device of the present embodiment is used as the light valves 100R, 100G, and 100B of the above-mentioned projection display device 1100. Herein, FIG. 2 is a plan view of the liquid crystal device illustrating a TFT array substrate and constructional components provided thereon, as viewed from a counter substrate side. FIG. 3 is a cross-sectional view taken along the line H-H′ shown in FIG. 2. However, the liquid crystal device has a driving circuit therein, and is driven by a TFT active matrix driving method.

(Structure of Liquid Crystal Device)

Referring to FIGS. 2 and 3, the liquid crystal device has a pair of a TFT array substrate 10 and a counter substrate 20 opposite to the TFT array substrate 10. A liquid crystal layer 50 is sealed between the TFT array substrate 10 and the counter substrate 20. The TFT array substrate 10 and the counter substrate 20 are bonded to each other by a sealing member 52 disposed at a sealing region which is located around an image display region 10a.

The sealing member 52, which is used for bonding both substrates, is made of, for example, an ultraviolet curable resin, thermosetting resin, or the like. In addition, gap members, such as glass fibers or glass beads, are dispersed in the sealing member 52 to keep the gap between the TFT array substrate 10 and the counter substrate 20 (the gap between the substrates) at a predetermined distance.

A frame-shaped light shielding film 53 for defining a frame region of the image display region 10a is provided on the counter substrate 20 around to the inner side of the sealing region where the sealing member 52 is disposed. However, a part or all of the frame-shaped light shielding film 53 may be provided at the inside of the TFT array substrate 10 as a built-in light shielding film.

Among the regions extending around the image display region, in the peripheral region located at the outer side of the sealing region where the sealing member 52 is disposed, a data line driving circuit 101 and external circuit connection terminals 102 are provided along one side of the TFT array substrate 10, and scanning line driving circuits 104 are provided along two sides adjacent to the one side so as to be covered with the frame-shaped light shielding film 53. In order to connect the two scanning line driving circuits 104 provided along the two sides of the image display region 10a to each other, a plurality of wiring lines 105 are provided along the other side of the TFT array substrate 10 so as to be covered with the frame-shaped light shielding film 53.

Further, vertical connection members 106 for serving as vertical connection terminals between the two substrates are disposed at four corners of the counter substrate 20. On the other hand, on the TFT array substrate 10, vertical connection terminals are provided at the regions opposite to the corners. These members enable electrical connection between the TFT array substrate 10 and the counter substrate 20.

In FIG. 3, pixel switching TFTs and wiring lines, such as scanning lines and data lines, are formed on the TFT array substrate 10 to form pixel electrodes 9a, and then, an alignment layer (not shown) is formed on the pixel electrodes 9a. On the other hand, a counter electrode 21 and a light shielding film 23 of a lattice or stripe shape are provided on the counter substrate 20. In addition, an alignment layer (not shown) is formed on the uppermost portion. The liquid crystal layer 50 is made of, for example, one kind of nematic liquid crystal or a mixture of plural kinds of nematic liquid crystal, and is held in a predetermined alignment state between the pair of alignment layers.

In addition to the data-line driving circuit 101 and the scanning line driving circuits 104, etc., a sampling circuit for sampling image signals on image signal lines to supply them to the data lines, a pre-charge circuit for supplying pre-charge signals having a predetermined voltage level to a plurality of data lines prior to the image signals, and a test circuit for inspecting the quality and defects of the electro-optical device during the manufacturing process or at the time of shipping may be formed on the TFT array substrate 10 shown in FIGS. 2 and 3.

(Structure of Optical Plate Member)

In this liquid crystal device, an optical plate member 410 is provided on the surface of the TFT array substrate 10 opposite to the liquid crystal layer 50 (a lower surface of the TFT array substrate 10 in FIG. 3). In addition, an optical plate member 420 is provided on the surface of the counter substrate 20 opposite to the liquid crystal layer 50 (an upper surface of the counter substrate 20 in FIG. 3).

The optical plate members 410 and 420 each include polycrystalline spinel (MgAl₂O₄). That is, the optical plate members 410 and 420 should include a sufficient amount of spinel to exhibit a noticeable physical effect, and may have a lower level of impurities. However, in the optical plate members of the invention, the structure of the spinel is not limited thereto. For example, the optical plate member may include monocrystalline spinel or bulk, and preferably, amorphous spinel. The optical plate members 410 and 420 including the spinel can be formed by, for example, a powder sintering method.

Herein, the optical plate members 410 and 420 including the spinel have the following features caused by the spinel.

First, the spinel has high transmittance. Therefore, there is no fear that the transmission light of the optical plate member will be colored or attenuated. For example, the optical plate members 410 and 420 each have AR films on both surfaces thereof, and thus the transmittance in this state is larger than 90% in the visible light band having a wavelength range of 450 to 780 nm.

Second, the spinel has high heat conductivity. Therefore, the heat conductivity (16.9 W/m·K) of the spinel is ten or more times higher than the heat conductivity (1.2 W/m·K) of quartz glass, which is generally used.

Third, the spinel has little or no optical anisotropy, particularly refractive index anisotropy. It is thought that this is because the spinel has an isotropic crystal system structure or a polycrystalline structure. In addition to the spinel, sapphire has been known as a material having a heat conductivity higher than quartz glass, but the refractive-index anisotropy thereof is relatively large.

As such, the optical plate members 410 and 420 have all features required for the optical plate members. Therefore, as described below, it is possible to display a high-quality image and to more effectively cool down a liquid crystal device during driving.

Further, AR films 503 and 504 are provided on the two surfaces of the optical plate member 410, respectively, and AR films 501 and 502 are provided on the two surfaces of the optical plate member 420, respectively. These AR films 501 to 504 are composed of a single film made of, for example, zirconia (ZrO₂) or silica (SiO₂), or a multi-layered film. In this way, it is possible to prevent loss caused by unnecessary reflection between members having different refractive indexes, for example, between an air layer (the upper side in FIG. 3) and the inside of the counter substrate 20 (the lower side in FIG. 3), and thus to effectively guide light between the members. Particularly, in the present embodiment, since the optical plate members 410 and 420 each include a relatively large amount of spinel having a refractive index higher than 1.7 and the AR films 501 to 504 are provided thereon, light reflection is prevented at the interfaces between these members, which is very effective in maintaining the brightness of a projection image.

Further, it is preferable that the respective AR films 501 to 504 have different structures. This is because different light reflection aspects can occur in the respective AR films 501 to 504. That is, in the AR film 501, it is necessary to prevent reflection when light travels from the air layer to the optical plate member 420, and in the AR film 502, it is necessary to prevent reflection when light travels from the optical plate member 420 to the counter substrate 20 made of, for example, quartz glass. In addition, in the AR film 503, it is necessary to prevent reflection when light travels from the TFT array substrate 10 made of, for example, quartz glass, to the optical plate member 410, and in the AR film 504, it is necessary to prevent reflection when light travels from the optical plate member 410 to the air layer.

Therefore, in this case, it is preferable to change the laminated structure of the AR films 501 to 504 by changing the thicknesses of the respective AR films 501 to 504, by changing the number of AR films, or by changing the materials forming the AR films. In this way, it is possible to properly cope with the above-mentioned different reflection aspects.

(Operation of Liquid Crystal Device)

Next, the operation of the liquid crystal device will be described on the basis of the operations of the optical plate members 410 and 420.

During the operation of the projection display device, intense projection light is emitted to the liquid crystal device from the upper side of FIG. 3. The projection light is incident on the liquid crystal device from the optical plate member 420 and is then modulated in the liquid crystal layer 50. Then, the modulated light is emitted from the optical plate member 410. Here, since the optical plate members 410 and 420 have high transmittance, there is no fear that light emitted therefrom will be colored or attenuated.

The incident angle of the projection light with respect to the counter substrate 20 varies in the image display region 10a. Therefore, when the optical plate member having a refractive index anisotropy is used, the contrast partially deteriorates or the viewing angle varies in the direction in which the refractive index anisotropy is exhibited. On the other hand, since the optical plate members 410 and 420 both have little or no refractive index anisotropy, it is possible to prevent defects in display.

Further, when an optical plate member made of, for example, sapphire, is used, it is necessary to adjust the positions of the substrates such that specifications that the user desires, such as the viewing angle, are satisfied and to align the substrates in the direction in which the anisotropy is exhibited. However, when the optical plate members 410 and 420 are used, the adjustment is not needed, and it is possible to cope with any specifications, which contributes to improving the manufacturing efficiency of a liquid crystal device.

Further, when dust is stuck to the image display region 10a of the liquid crystal device, the image of the dust is projected onto the screen, resulting in the deterioration of image quality. However, since the optical plate members 410 and 420 are respectively arranged on the TFT array substrate 10 and the counter substrate 20, dust is not stuck on the counter substrate 20 or the TFT array substrate 10, but is stuck on the surface of the AR film 501 or the AR film 504. Therefore, the dust is stuck at the position separated from a focusing point by a distance corresponding to the total thickness of the optical plate members 410 and 420 and the AR films 501 to 504. Therefore, an image of dust is not formed due to the defocus effect, thereby preventing the deterioration of image quality.

Thus, it is possible to prevent the deterioration of the image quality of a liquid crystal device as well as a projection display device by providing the optical plate members 410 and 420 in the liquid crystal device.

Furthermore, during the driving of the projection display device, the counter substrate 20, the liquid crystal layer 50, and the TFT array substrate 10 emit heat when absorbing light, which results in an increase in temperature of the liquid crystal device. The increase in temperature causes the deterioration of the liquid crystal layer 50 and display quality. However, in the present embodiment, since the optical plate members 410 and 420 have high heat conductivity, the heat generated from the liquid crystal device is transmitted with high conductivity from the substrates of the TFT array substrate 10 and the counter substrate 20 to the optical plate members 410 and 420, and is then dissipated outside. That is, the optical plate members 410 and 420 also serve as cooling members having good efficiency in the liquid crystal device to suppress the increase in temperature of the liquid crystal device.

Therefore, it is possible to more effectively radiate heat and to prevent the excessive accumulation of heat in the liquid crystal display device by providing the optical plate members 410 and 420 in the liquid crystal device. Thus, since the heat accumulated in the liquid crystal layer is more effectively dissipated outside, as described above, the sirocco fan 1300 does not need to have a high cooling performance in the present embodiment. That is, it is possible to reduce the amount of wind compared to the related art. Thus, it is possible to reduce the power consumption of the sirocco fan 1300 and to reduce the noise of the sirocco fan 1300.

As described above, according to the present embodiment, it is possible to solve the problems caused by the dust or refractive index anisotropy of the optical plate member and to display a high-quality image. In addition, it is possible to prevent the deterioration of an electro-optical material and to stably operate a liquid crystal device by effectively cooling down the liquid crystal device during driving.

(Modifications)

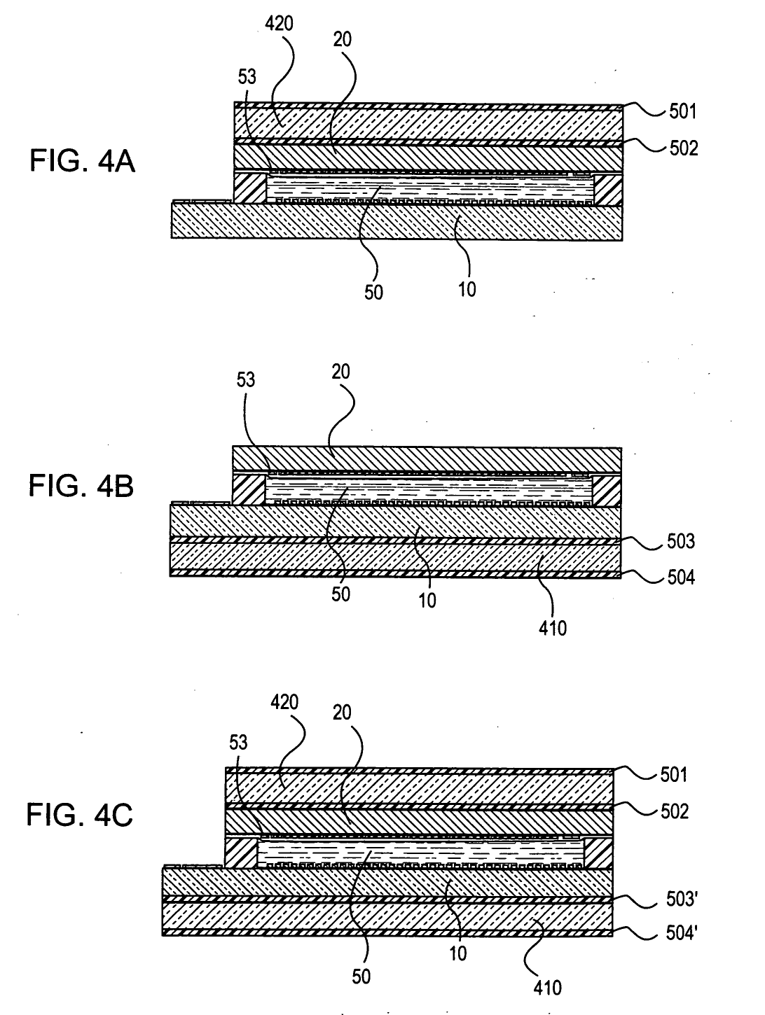

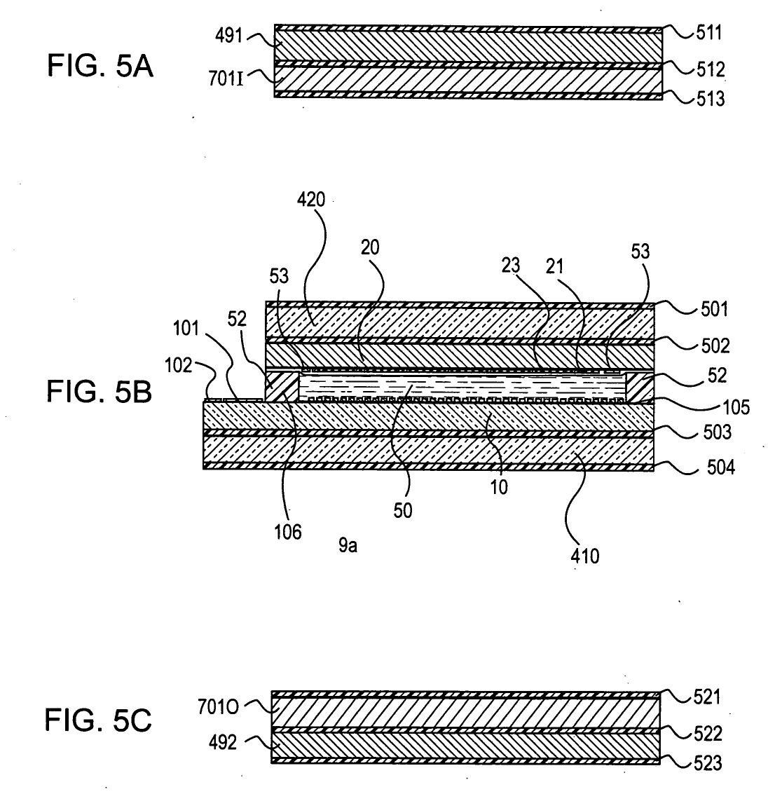

Hereinafter, modifications of the first embodiment of the liquid crystal device will be described with reference to FIGS. 4 and 5.

(First Modification)

First, the first modification will be described with reference to FIG. 4. FIG. 4 is a cross-sectional view of the liquid crystal device of this embodiment and illustrates various aspects different from FIG. 3.

As shown in FIG. 4A, the optical plate member 420 including spinel may be arranged on only the counter substrate 20. Alternatively, as shown in FIG. 4B, the optical plate member 410 including spinel may be arranged on only the TFT array substrate 10.

Further, as shown in FIG. 4C, the optical plate member 420 including the spinel may be provided on the counter substrate 20, and an optical plate member 411 not including the spinel may be provided on the TFT array substrate 10. Herein, the optical plate member 411 corresponds to the second optical plate member of the invention. However, since the optical plate member 411 can be made of a relatively stable material, it is possible to reduce the total manufacturing cost of the liquid crystal device. In addition, since the optical plate member 411 does not include spinel, generally, there is low possibility that the reflection of incident light or emission light will occur at the interface of the optical plate member 411. However, it is not that no reflection occurs at the interface of the optical plate member 411. Thus, AR films 503′ and 504′ (see FIG. 4C) are provided to cope with the reflection.

As such, the optical plate members can be arranged in various manners, and the cooling effect of the liquid crystal device is exhibited according to the manners. However, in order to obtain the highest heat dissipation effect of the liquid crystal device, the optical plate members 410 and 420 not including spinel are preferably provided on the light incident side and the light emission side of the liquid crystal device, respectively (see FIG. 3). In addition, when the optical plate member is provided on only one side of the liquid crystal device, it is preferable that the optical plate member be provided on the light incident side (that is, FIG. 4A) rather than on the light emission side (that is, FIG. 4B).

(Second Modification)

Next, a second modification will be described with reference to FIG. 5. FIG. 5 is a cross-sectional view of the liquid crystal device, and illustrates various aspects different from FIG. 3.

In FIG. 5, the liquid crystal device further includes polarizing plates 701I and 701O respectively arranged on the upper and lower sides of FIG. 5, in addition to the components shown in FIG. 3. The polarizing plates 701I and 701O are a kind of polarizing element for properly polarizing light incident on the liquid crystal layer 50 and light emitted from the liquid crystal layer 50. In this way, it is possible to continuously perform adjustment from a state in which incident light is substantially completely transmitted to a state in which the incident light is substantially completely shielded, by adjusting the relationship between the alignment state for properly aligning the liquid crystal layer 50 and the polarization states of the polarizing plates 701I and 701O.

Particularly, in the second modification, temperature rising preventing substrates 491 and 492 are respectively provided on the polarizing plates 701I and 701O, as shown in FIG. 5. These temperature rising preventing substrates 491 and 492 correspond to ‘third optical plate members’.

Further, AR films 511 to 513 are respectively provided at the interfaces of a structure composed of the polarizing plate 701I and the temperature rising preventing substrate 491, and AR films 521 to 523 are respectively provided at the interfaces of a structure composed of the polarizing plate 701O and the temperature rising preventing substrate 492.

According to this structure, it is possible to obtain the same effects as those in the first embodiment using the polarizing plates 701I and 701O. That is, when the dustproof substrates 410 and 420 including spinel are used, the refractive index anisotropy does not occur although the polarized light is used. Thus, according to the second modification, it is possible to obtain higher-quality display.

Further, the polarizing plates 701I and 701O are optical elements having fear that heat will be accumulated when light is incident thereon. However, since the temperature rising preventing substrates 491 and 492 are provided, it is possible to effectively radiate heat accumulated in the polarizing plates 701I and 701O to the outside.

Furthermore, in the present modification, a λ/4 plate, a λ/2 plate, an optical compensation film (not shown) for a wide viewing angle, etc., are provided as optical compensation elements, in addition to the components shown in FIG. 5, and the ‘optical plate members’ of the invention may be provided as the optical compensation elements. In this case, it is possible td more reliably suppress display defects caused by the refractive index anisotropy and to radiate the heat accumulated in the optical compensation elements.

### Second Embodiment of Liquid Crystal Device

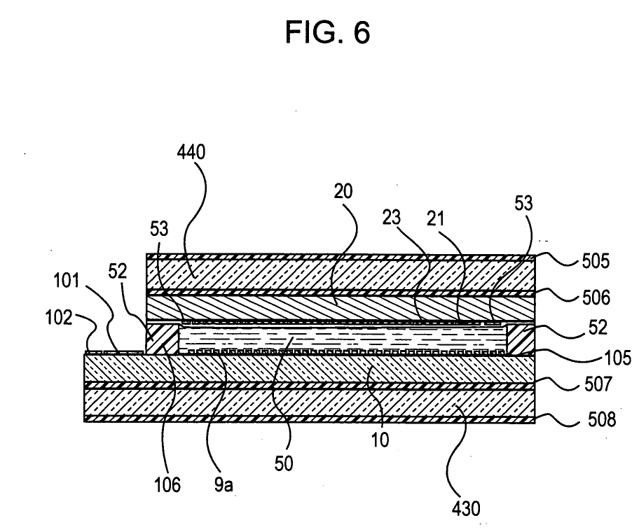

Next, a second embodiment of the liquid crystal device according to the invention will be described with reference to FIG. 6. FIG. 6 corresponds to FIG. 3 and illustrates the sectional structure of the liquid crystal device according to the second embodiment. In the present embodiment, the same components as those in the first embodiment have the same reference numerals, and the description thereof will be omitted.

(Structure of Liquid Crystal Device)

As shown in FIG. 6, in the present embodiment, optical plate members 430 and 440 are respectively provided on the light incident side and the light emission side of the liquid crystal device. That is, the optical plate members 430 and 440 are provided instead of the optical plate members 410 and 420 of the first embodiment.

The optical plate members 430 and 440 each include polycrystalline YAG. That is, the optical plate members 430 and 440 should include a sufficient amount of YAG to exhibit a noticeable physical effect, and may have a low level of impurities. Herein, the substrate composition of the YAG is Y₃Al₅O₁₂. However, in the optical plate members of the invention, the structure of the YAG is not limited thereto. For example, the optical plate members may include monocrystalline YAG or bulk, and preferably, amorphous YAG. The optical plate members 430 and 440 including the YAG can be formed by, for example, a powder sintering method or a slip casting method.

Herein, the optical plate members 430 and 440 including the YAG have the same features as the optical plate members 410 and 420 including the spinel.

That is, first, the YAG has high transmittance. Second, the heat conductivity (11.7 W/m·K) of the YAG is ten or more times higher than the heat conductivity (1.2 W/m·K) of quartz glass generally used. Third, the YAG has little or no optical anisotropy, particularly a refractive index anisotropy. It is thought that this is because the YAG has an isotropic crystal system structure or a polycrystalline structure.

As such, the optical plate members 430 and 440 have all features required for the optical plate members. Therefore, as described below, it is possible to display a high-quality image and to more effectively cool down a liquid crystal device during driving.

Further, AR films 507 and 508 are provided on the two surfaces of the optical plate member 430, respectively, and AR films 505 and 506 are provided on the two surfaces of the optical plate member 440, respectively. These AR films 505 to 508 are composed of a single film made of, for example, zirconia (ZrO₂) or silica (SiO₂), or a multi-layered film. These AR films 505 to 508 have the same effects and operations that the AR films 501 to 504 have in the first embodiment.

(Method of Manufacturing Liquid Crystal Device)

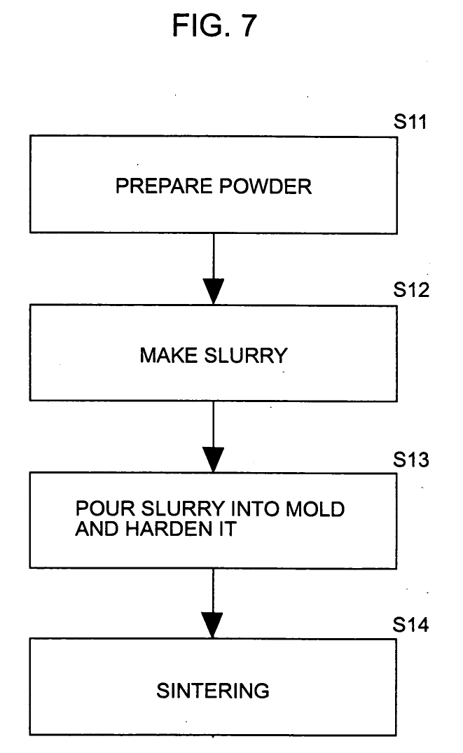

Next, a method of manufacturing the liquid crystal device according to the second embodiment will be described with reference to FIG. 7. FIG. 7 is a flow chart illustrating the main processes of the method of manufacturing the liquid crystal device according to the present embodiment.

The liquid crystal device according to the present embodiment can be manufactured by a general manufacturing method, except that the optical plate members 430 and 440 are made of a material different from the material forming the optical plate member, which is generally used as ‘a dustproof substrate’. Therefore, in the present embodiment, a process of manufacturing the optical plate members 430 and 440 will be mainly described.

That is, necessary components, such as pixel electrodes 9a, are formed on one surface of the TFT array substrate 10, and necessary components including a counter electrode 21 are formed on one surface of the counter substrate 20. Then, the TFT array substrate 10 and the counter substrate 20 are bonded to each other using the sealing material 52 such that the surfaces thereof having the electrodes thereon face each other. Subsequently, liquid crystal is injected into the gap between the substrates.

The optical plate members 430 and 440 are prepared according to the process shown in FIG. 7 after or before the above-mentioned process or at the same time of the process.

First, a powder including YAG is prepared (step S11). The powder is preferably-composed of YAG with the highest possible purity, and the diameter of the particles of the powder is properly adjusted in the balance with the following processes.

Then, this powder is mixed with a solvent, such as pure water, to prepare slurry (step S12). Subsequently, the slurry is poured into a mold and is then hardened (step S13). In this way, the precursor of an optical plate member molded in a plate shape is obtained.

Successively, the precursor is sintered (step S14). Herein, conditions, such as a sintering temperature, etc., are properly-adjusted. In this way, the optical plate members 430 and 440 are manufactured.

The AR films 501, 502, 503, and 504 are respectively provided on the optical plate members 430 and 440 manufactured in the above-mentioned manner.

Thereafter, the optical plate members 430 and 440 are arranged on the surfaces of the TFT array substrate 10 and the counter substrate 20 opposite to each other (that is, the surfaces of the TFT array substrate 10 and the counter substrate 20 opposite to the liquid crystal layer 50). This can be realized by encasing these members in the case in a state in which they overlap each other, as described later.

Since the optical plate members are formed by a so-called slip casting method for molding slurry into a part, the molded part (that is, a precursor) is little damaged. Therefore, it is possible to easily manufacture the optical plate members 430 and 440 and thus to improve the yield of a liquid crystal device.

Further, the powder is used as a starting material, and the powder is molded without applying pressure, in order to disperse anisotropy. Therefore, the method of manufacturing the optical plate members 430 and 440 according to the present embodiment is more advantageous than other methods.

(Operation of Liquid Crystal Device)

It is possible to operate the liquid crystal device of the present embodiment in the same manner as the first embodiment.

That is, during the operation of the projection display device, intense projection light is emitted to the liquid crystal device from the upper side of FIG. 6. Here, since the optical plate members 430 and 440 have high transmittance, there is no fear that light emitted therefrom will be colored or attenuated.

Further, since the optical plate members 430 and 440 both have little or no refractive index anisotropy, it is possible to prevent the variation of the viewing angel or the partial lowering of the contrast in the direction in which the refractive index anisotropy is exhibited, caused by the variation of the incident angel of the projection light and the refractive index anisotropy of the optical plate member. In addition, this property makes it unnecessary to adjust the position of the optical plate member having the refractive index anisotropy. Thus, it is possible to cope with any specifications, which contributes to improving the manufacturing efficiency of a liquid crystal device.

Further, since the optical plate members 430 and 440 are respectively arranged on the TFT array substrate 10 and the counter substrate 20, dust is not stuck to the surface of the counter substrate 20 or the TFT array substrate 10. Although dust is stuck, an image of dust is not formed due to the defocus effect, thereby preventing the deterioration of image quality.

Furthermore, since the optical plate members 430 and 440 have high heat conductivity, the heat generated when the liquid crystal is driven is transmitted with high conductivity from the surfaces of the TFT array substrate 10 and the counter substrate 20 to the optical plate members 430 and 440 and is then dissipated outside. Therefore, it is possible to more effectively radiate heat and thus to prevent the excessive accumulation of heat in a liquid crystal device.

As described above, according to the present embodiment, it is possible to solve the problems caused by the dust or refractive index anisotropy of the optical plate member and to display a high-quality image. In addition, it is also possible to prevent the deterioration of an electro-optical material and to stably operate a-liquid crystal device by effectively cooling-down the liquid crystal device during driving.

### Third Embodiment of Liquid Crystal Device

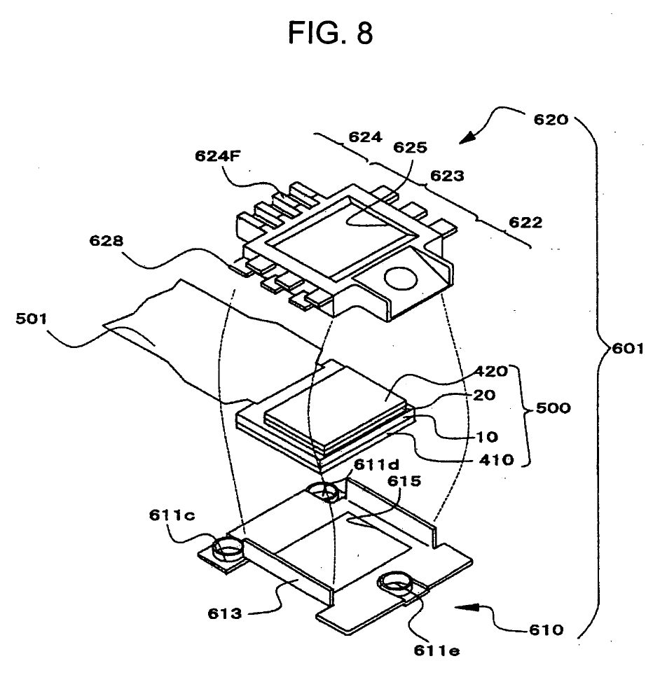

Next, an electro-optical device-according to a third embodiment will be described with reference to FIG. 8. FIG. 8 is an exploded view of a liquid crystal device according to the present embodiment. The liquid crystal device according to the present embodiment has the same structure as the liquid crystal device of the first embodiment, except that the liquid crystal device is housed in a case 601. Therefore, in the third embodiment, the same components as those in the first embodiment have the same reference numerals, and the description thereof will be omitted for the simplicity of explanation. However, the second embodiment is different from the first embodiment in that the optical plate members are made of different materials, but has the same effects and operations as the first embodiment. Thus, the liquid crystal device of the present embodiment housed in the case 601 may have the same structure as the liquid crystal device of the second embodiment.

In FIG. 8, a liquid crystal display unit 500 corresponds to the liquid crystal device of the first embodiment. The liquid crystal display unit 500 having the above-mentioned optical plate members 410 and 420 is housed in the case 601 including a plate part 610 and a cover part 620. In addition, mounting holes 611c, 611d, and 611e are formed in the plate part 610, and the case 601 can be appropriately mounted to the projection display device 1100 by the mounting holes 611c, 611d, and 611e. More specifically, the case 610 can be mounted to the projection display device 1100 by inserting external screws (not shown) into interior screws formed in a mounting surface (not shown) constituting a portion of the projection display device 1100 through the mounting holes 611c, 611d, and 611e and by tightening the screws.

Further, window parts 615 and 625 are respectively provided in the plate part 610 and the cover part 620. Light can be incident on or emitted from the liquid crystal display unit 500 through the window parts 615 and 625. In addition, a circumferential portion of the optical plate member 410 comes into contact with an edge portion of the window part 615, and a circumferential portion of the optical plate member 420 comes into contact with an edge portion of the window part 625.

Furthermore, the cover part 620 further includes a cooling air introducing part 622 having an inclined plane and a cooling air discharging part 624, and a cover main body 623, so that it is possible to uniformly blow the cooling air (the air supplied from the sirocco fan 1300 shown in FIG. 1) to the entire surface of the cover part 620, thereby effectively cooling down the cover part 620. It is preferable that the cooling air flow in the order of the cooling air introducing part 622, the cover main part 623, and the cooling air discharging part 624. In order to implement the blow of the cooling air, it is preferable to arrange the liquid crystal devices, serving as light valves, such that the cooling air introducing parts 622 face outlets 100RW, 100GW, and 100BW, in the projection display device 1100 shown in FIG. 1.

Further, the cover main body part 623 has side fins 628 formed in zigzags, and the cooling air discharging part 624 has a rear fin part 624F. In this way, it is possible to improve the heat radiating performance of the cover part 620.

Furthermore, bent portions 613 are formed in the plate part 610 so as to face both side surfaces of the liquid crystal display unit 500 and so as to abut on the inner side surfaces of the cover part 620. Therefore, the bent portions 613 enable heat to be effectively transmitted from the liquid crystal display unit 500 to the plate part 610 and the cover part 620.

Moreover, FIG. 8 shows a flexible connector 501 connected to the external circuit connecting terminals 102 shown in FIG. 2 in the liquid crystal display unit 500.

Next, the effect and operation of the liquid crystal device having the above-mentioned structure will be described.

In the present embodiment, since the liquid crystal display unit 500 has the optical plate members 410 and 420, the heat of the liquid crystal device is first transmitted to the optical plate members 410 and 420. Then, the heat of the optical plate members 410 and 420 is transmitted to the cover part 620 and the plate part 610. At that time, since the edge portions of the window parts 615 and 625 come into contact with the circumferential portions of the optical plate members 410 and 420, respectively, the heat of the optical plate members 410 and 420 are more effectively transmitted to the plate part 610 and the cover part 620.

Further, the cover part 620 is provided with the side fin portions 628 and the rear fin portion 624F, and the plate part 610 is provided with the bent portions 613, which causes heat to be effectively transmitted between the plate part 610 and the cover part 620. Therefore, the heat transmitted from the liquid crystal display unit 500 to the cover part 620, or the heat transmitted from the liquid crystal display unit 500 to the cover part 620 through the plate part 610 is rapidly dissipated outside. As such, the cover part 620 and the plate part 610 function as heat sinks in the liquid crystal display unit 500.

In the present embodiment, since the case 601 having the above-mentioned structure is provided, it is possible to more effectively radiate heat from the liquid crystal device to the outside.

Furthermore, when the case 601 as well as the optical plate members 410 and 420 functions as a heat sink, in order to more effectively realize the function, it is preferable that at least one of the cover part 620 and the plate part 610 be made of a metallic material having heat conductivity equal to or higher than 15 W/m·K. For example, aluminum, magnesium, copper, or an alloy thereof may be given as an example of the metallic material.

Moreover, when the liquid crystal display unit 500 further includes the polarizing plates 701I and 701O and the temperature rising preventing substrates 491 and 492, these components are generally arranged at the outside of the case 601. That is, only the portion shown at the middle of FIG. 5 is housed in the case 601, and the other portions shown at the upper and lower sides of FIG. 5 are arranged at the outside of the case 601.

The invention is not limited to the above-mentioned embodiments, and can be appropriately modified without departing from the scope and spirit of the invention defined by the specification and claims. Therefore, an electro-optical device, a method of manufacturing the electro-optical device, and an electronic apparatus equipped with the electro-optical device, which are modifications of the invention, are also included in the technical scope of the invention.

For example, the liquid crystal device of the first embodiment has the optical plate members each including spinel, and the liquid crystal device of the second embodiment has the optical plate members each including YAG. However, the liquid crystal device may have both an optical plate member including the spinel and an optical plate member including the YAG.

Further, the ‘displaying electrodes’ of the invention may be stripe-shaped electrodes other than the pixel electrodes and the counter electrode (common electrode), which are formed to intersect each other on a pair of substrates. In this case, it is possible to drive a liquid crystal device in a passive matrix driving manner.

Furthermore, the liquid crystal device has been given as an example of the electro-optical device of the invention. However, the electro-optical device of the invention can be applied to various devices that generate heat when they are driven, such as display devices using digital micromirror devices (DMDs), electrophoresis devices, field emission display devices, and surface-conduction electron-emitter display devices, in addition to the liquid crystal display device. The electro-optical device of the invention can also be applied to a reflective projector as well as the projection display device. In addition, the electro-optical device can be applied to various display devices, such as TV picture tubes, as a light valve.

Moreover, the invention can be applied to a liquid crystal device (LCOS) in which transistors are formed on a silicon substrate and a reflective light valve, such as a DMD in which movable mirrors are formed on a silicon substrate.

When the invention is applied to LCOS, an optical plate member including spinel or YAG is preferably provided on the surface of the counter substrate 20 opposite to the liquid crystal layer 50.

Further, in case of DMD, it is preferable that an optical plate member including spinel or YAG be provided on a reflective surface having a micromirror thereon. In this case, the optical plate member is preferably mounted on the reflective surface so as not to come into contact with the surface of the micromirror. More specifically, preferably, convex portions or gap maintaining particles are provided in the silicon substrate (or a base substrate) of the DMD for supporting the optical plate member, and the optical plate member is fixed on the convex portions or gap maintaining particles.

Furthermore, the reflective device, such as LCOS or DMD, can obtain the effect of the invention by providing the optical plate member in the direction in which light incident on the substrate is reflected, that is, in the emission direction of light.

Moreover, the electro-optical device of the invention can be applied to various electronic apparatuses other than the above-mentioned projector, such as television sets, view-finder-type or monitor-direct-view-type videotape recorders, car navigation systems, pagers, electronic organizers, electronic calculators, word processors, workstations, TV phones, POS terminals, and apparatuses equipped with touch panels.

1. An electro-optical device comprising:
a pair of substrates having an electro-optical material therebetween;
pixels that are provided on one of the pair of substrates; and
a plate member which includes spinel and is provided on a surface of at least one of the pair of substrates opposite to the electro-optical material.

2. An electro-optical device comprising:
a pair of substrates having an electro-optical material therebetween;
pixels that are provided on one of the pair of substrates; and
a plate member which includes YAG (Yttrium Aluminum Garnet) and is provided on a surface of at least one of the pair of substrates opposite to the electro-optical material.

3. The electro-optical device according to claim 2,
wherein the composition of the YAG included in the plate member is Y₃Al₅O₁₂.

4. The electro-optical device according to claim 1,
wherein the plate member is made of a polycrystalline material.

5. The electro-optical device according to claim 1,
wherein the plate member is a member obtained by sintering powder.

6. The electro-optical device according to claim 1,
wherein the plate member is provided on the surface of one of the pair of substrates opposite to the electro-optical material, and
a plate member including neither spinel nor YAG is provided on a surface of the other substrate of the pair of substrates opposite to the electro-optical material.

7. The electro-optical device according to claim 1,
wherein a polarizing element is further provided on the surface of at least one of the pair of substrates opposite to the electro-optical material.

8. The electro-optical device according to claim 7,
wherein the polarizing element is provided with the plate member including spinel or YAG.

9. The electro-optical device according to claim 1,
wherein an AR (Anti-Reflection) film is provided on at least one surface of the plate member.

10. The electro-optical device according to claim 1, further comprising a case in which at least the pair of substrates and the plate member are encased and which is composed of a plurality of detachable components.

11. An electro-optical-device comprising a substrate having reflective pixel electrodes that reflect incident light,
wherein a plate member including spinel is provided at the side where the light incident on the substrate is reflected.

12. An electro-optical device comprising a substrate having reflective pixel electrodes that reflect incident light,
wherein a plate member including YAG is provided at the side where the light incident on the substrate is reflected.

13. An electronic apparatus comprising the electro-optical device according to claim 1.
